(19) United States
(12) Patent Application Publication
(10) Pub. No.: US 2010/0106263 A1
(43) Pub. Date: Apr. 29, 2010

(54) SYSTEM FOR REVENUE MANAGEMENT USING LOCATION BASED SERVICES

(75) Inventor: Aamer Charania, Flower Mound, TX (US)

Correspondence Address: VERIZON;PATENT MANAGEMENT GROUP, 1320 North Court House Road, 9th Floor, ARLINGTON, VA, 22201-2909, US

(73) Assignee: Verizon Data Services LLC, Temple Terrace, FL (US)

(21) Appl. No.: 12/259,682

(22) Filed: Oct. 28, 2008

(51) Int. Cl. G05B 15/02; G06Q 30/00

(52) U.S. Cl. 700/36; 705/400; 705/26

(57) ABSTRACT

A method for revenue management using location based services includes setting a static offering price of an offered product and monitoring a geographic sales region for at least one potential customer. The offering price may be optimized into a targeted price based on at least one dynamic attribute of the one potential customer and distributed to the at least one potential customer. A system for implementing the disclosed method includes a communication network, at least one communication device operable therewith and associated with a potential customer, and a processor configured to communicate with the communication device using the communication network that has a computer readable medium including instructions for controlling the processor.

### BACKGROUND

When a firm produces a good or provides a service, collectively an offering, it must set the price of the offering at a level that is acceptable to purchasers. Typically, in the case of goods the firm will set the price at the level where marginal revenue is more than the marginal costs of production. A similar approach takes place with respect to services, but the ability to provide the service (e.g., bandwidth) and the amount of demand for the service will be factors. Such an approach assumes that all purchasers will purchase the offering for the same price.

Differential pricing techniques may be useful in increasing profits when different customers are willing to purchase the same good or service at different prices. Differential pricing may be more effective with certain types of goods or services, such as perishable goods and goods with high fixed costs and low variable or marginal costs. For example, the value of a perishable good will generally decrease over time. Accordingly, the price that purchasers will be willing to pay will generally decrease over the life of the good. It can be advantageous to decrease the price of the good over the life span of the good until such time that the expected marginal revenue no longer exceeds the marginal cost of production. Similarly, in the case of services, it may be desirable to reduce the price for providing the service until it no longer exceeds the marginal cost for providing the service. Another example may be to reduce the price of the goods or services for customers that will not buy at the higher price. Again, to make a profit, the price reduction can continue as long as the marginal cost of producing the service is more than the expected marginal revenue.

### BRIEF DESCRIPTION OF THE DRAWINGS

FIG. 1 is a diagram of an exemplary system for revenue management using location based services;

FIG. 2a is a representation of a geographic sales region with distance based probability bands;

FIG. 2b is a representation of another exemplary sales region with probability bands based on the potential customers ability to access a sales initiator such as a geographically fixed point of sale;

FIG. 3 is a flowchart depicting exemplary steps and decisions related to entering capacity and sales region data;

FIG. 4 is a flowchart depicting exemplary steps and decisions related to both monitoring a sales region for potential customers and optimizing prices for potential customers in a sales region.

### DETAILED DESCRIPTION

Exemplary illustrations of a system for revenue management using location based services are described below. In the interest of clarity, not all features of an actual implementation are described in this specification. It will of course be appreciated that in the development of any such actual illustration, numerous implementation-specific decisions must be made to achieve the specific goals of the developer, such as compliance with system-related and business-related constraints that will vary from one implementation to another. Moreover, it will be appreciated that such a development effort might be complex and time-consuming, but would nevertheless be a routine undertaking for those having the benefit of this disclosure.

Referring now to the drawings wherein like numerals indicate like or corresponding parts throughout the several views, exemplary illustrations are provided.

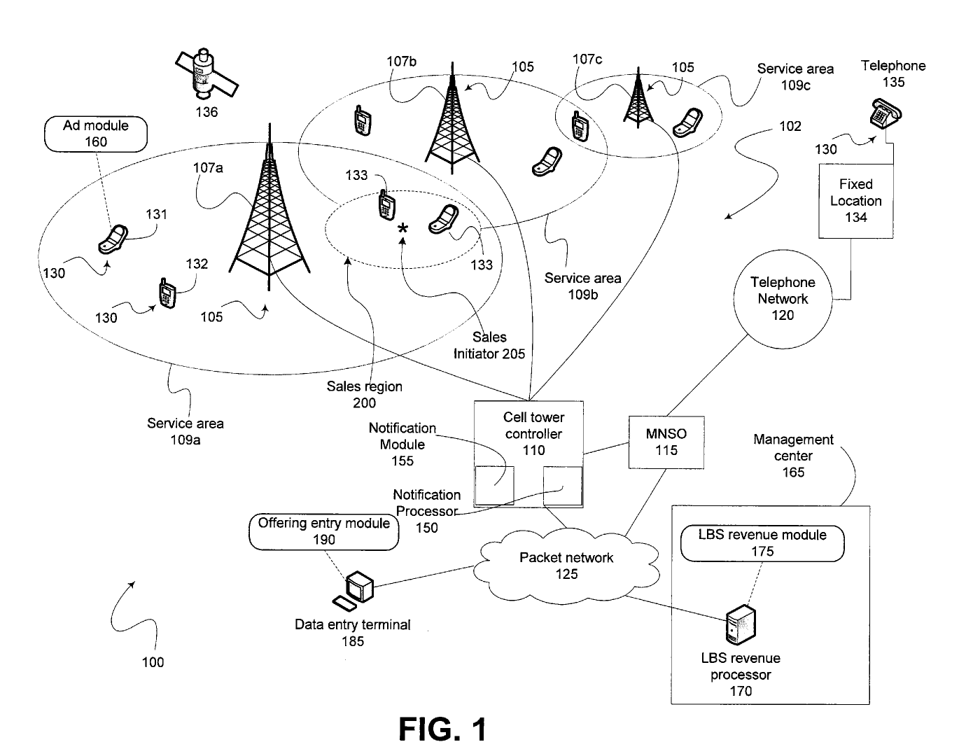

FIG. 1 illustrates a system 100 for revenue management using location based services. Details of the elements depicted in the figures are included following a brief functional overview of the system 100 and method.

System 100 utilizes an existing communications infrastructure to provide targeted advertisements directed to sales offerings of products or services. The communications infrastructure could include, among others, a wireless systems such as a mobile communication network 102, a computer network such as a Local Area Network (LAN) (not shown), a telephone network (not show), a cable television network (not shown), etc. Using a communications infrastructure in which the locations of communication devices can be determined may allow for revenue management calculations to be optimized based on dynamic attributes, including for example, the current dynamic location of a potential customer (e.g., while driving a car or walking) or the ability of the customer to reach a geographically fixed point of sale from a current dynamic location. Moreover, communications such as advertisements directed to targeted customers in a particular probability band within a defined geographic-based sales region, as well as to individual customers, may be distributed over the communications infrastructure to the communication devices associated with the targeted customers.

In an exemplary illustration of system 100, a mobile communication network 102 may include a plurality of communication facilities 105 such as cell towers 107a-c. The cell towers 107a-c may be controlled by a cell tower controller 110. The cell tower controller 110 may include connections to a Mobile Network Switching Office (MNSO) 115, a telephone network 120, and a packet switched network 125. In some other exemplary approaches, system 100 may narrow its focus to telephone network 120 or packet network 125, so long as the communication devices associated with the targeted customers are able to participate in the capturing of the necessary dynamic attributes as set forth below.

In the illustrated example, the mobile communication network 102 may provide communication services to a plurality of non-fixed communication devices 130, e.g. mobile phones 131, smart phones 132, and any other device configured to communicate with the communications facilities 105. Telephone network 120 typically includes fixed locations 134 including communication devices 130 such as a landline telephone 135. Fixed locations are generally known by geographical coordinates such as addresses, which can be translated into alternative coordinate systems such as latitude and longitude determinations. Similarly, geographic coordinates can be determined by way of packet network 125. The determination of geographic coordinates for non-fixed communication devices within communication network 102 is discussed in greater detail below.

Cell towers 107a-c may include one or more radio receivers and transmitters to communicate with communication devices 130 within range. The range of the cell towers 107a-c may be defined as service areas 109a-c. The service areas 109a-c are depicted with a uniform shape merely for simplicity of illustration. The actual service areas 109a-c are likely to be irregular due to interferences and topography. Additionally, the receivers and transmitters of the cell towers 107a-c may be arranged in a directional manner, e.g., a set of three groups of receivers and transmitters with each group covering 180 degrees. A network operator may also add additional receivers or transmitters to cover specific, irregular areas that, for what ever reason, do not receive service from cell towers 107a-c. The communication facilities 105, e.g., cell towers 107a-c, are positioned at fixed locations which are known and recorded by the network operator. The service areas 107a-c of the communication facilities 105 are also tracked by the network operators in order to accurately portray the extent of the mobile communication network 102, as well as to avoid redundant placement of facilities.

One or more cell towers 107a-c may be controlled by a cell tower controller 110. The cell tower controller 110 typically includes communication processing equipment (not show) to control the wireless communication between a particular tower 107a and a communication device 130. The controller 110 may also handle the hand-off of the communication between the communication device 130 and the tower 107a to another tower 107b as the device moves from one service area 109a to the next 109b. The cell tower controller 110 may also include wired or optical network connections to a mobile network switching office (MNSO) 115. The MNSO 115 typically includes telephone switching equipment (not show) to route call traffic between other MNSOs 115 and cell tower controllers 110 and may also interface with a telephone network 120, e.g., a public switched telephone network. Some mobile communication networks 102 may combine the functionality of the cell tower controller 110 and the MNSO 115.

The cell tower controller 110 may maintain records of the communication devices 130 within the service areas 109a-c of the cell towers 107a-c. For example, the records may include attributes related to the communication device 130 and the contact therewith, e.g., an identifier of the device 130, the time of last contact, the signal strength, the direction of the signal, the time difference between the time the signal was sent and the time it was received, etc. These attributes may be used by the cell tower controller 110 to determine which cell tower 107a-c should best handle the communication with the device 130. For example, the signal strength or time difference may be used to determine that the communication device 130 should be handed off to another cell tower 107a-c, and perhaps transferred to another cell tower controller 110 (only one shown).

Both the MNSO 115 and the cell tower controller 110 may connect to a packet network 125 to send and receive packet based data communications. For example, the packet network 125 may be used to transmit commands and data, including voice communication data, e.g., Voice Over Internet Protocol (VOIP), to the MNSO 115 and the cell tower controller 110. The packet network 125 may be a packet switched communication network such as an Internet Protocol (IP) network. The packet network 125 generally interconnects various computing devices and the like through a common communication protocol, e.g. the Internet Protocol. Interconnections in and with the packet network 125 may be made by various media including wires, radio frequency transmissions, and optical cables. Other devices connecting to and included with the packet network 125, e.g., switches, routers, etc., are omitted for simplicity of illustration in FIG. 1.

A constellation of satellites 136 (only one shown) may implement a satellite based navigation system, e.g., the Global Positioning System (GPS). Many mobile communication devices 130 include a satellite receiver configured to determine a dynamic geographic location based on transmissions received from the satellites 136. For example, the navigation satellite 136 may transmit highly accurate time values and ephemeris data that when compared with the time values and ephemeris data received from other satellites can be used by a mobile communication device 130 to determine its current location. The location may then be converted to a latitude and longitude reading in degrees, minutes, and seconds, and may further be depicted graphically on map displayed by the communication device 130.

Due to the power consumption of a satellite navigation receiver and the typically limited battery life of most mobile communication devices 130, the satellite based navigation receiver may be activated for only as long as needed to determine the dynamic location of the device 130. For example, the satellite based navigation receiver may be temporarily activated based on input the device 130 indicating that the location should be determined. Additionally, the cell tower controller 110, or other components of the communication network 102, may instruct the communication device 130 to determine its dynamic location and transmit the information in a manner that is ultimately received within system 100, such as by management center 165. Some governmental authorities mandate that mobile communication devices 130 that have satellite based navigation receivers be able to report their location without the assistance or input of the operator in the case of emergency calls, e.g., 911 calls. The cell tower controller 110 may additionally receive and record the location of the mobile communication device 130. Location may be stored or logged for a period of time.

The above-described mobile telecommunication network 102 may be supplemented with additional components to complete system 100. Communication devices 130 may include an alert module 160 capable of receiving communications such as advertisements directed to an offering in the form of a product or service. For example, alert module 160 may receive targeted ads for local stores, movie theaters, restaurants, local events, service offerings such as oil changes, etc. Typically, such targeted communications are applicable to a product or service that is offered in a specific geographic region or whose value is dependent upon real-time information related to dynamic attributes of a potential customer such as location, distance to an offering, or the accessibility of an offering.

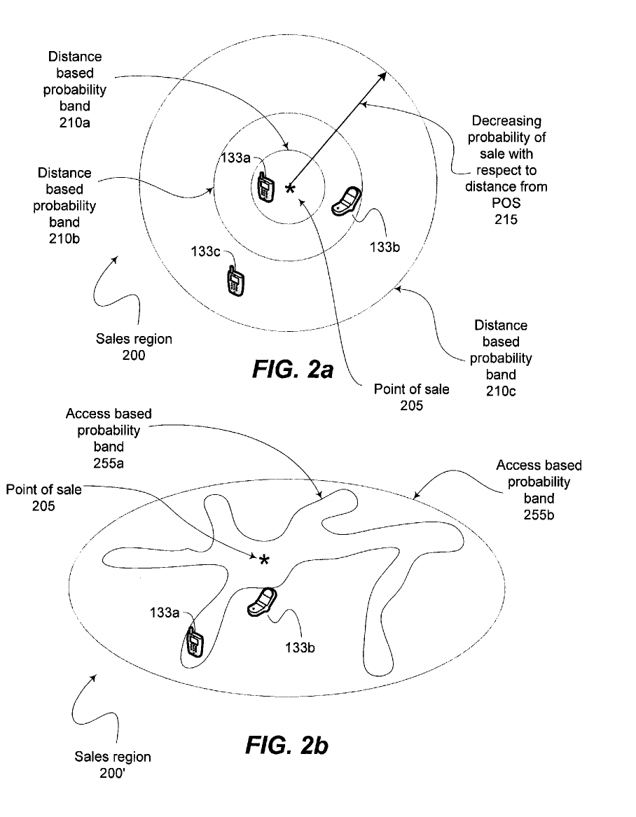

Moreover, as illustrated in FIG. 1, communication devices 130 may be located within a geographic sales region 200 encompassing a sales initiator 205. In FIG. 1 the sales initiator is illustrated as a point of sale 205, which may be geographic based and potentially geographically fixed within sales region 200. However, such a geographically fixed sales initiator 205 is merely exemplary. Sales region 200 and sales initiator 205 are discussed in greater detail with respect to FIGS. 2a and 2b below.

Once a sales region 200 is identified, the communications infrastructure may be used to discover communication devices 130 that should potentially be notified within the appropriate region. For example, the system 100 could be configured to notify only those devices within the sales region, those devices in the sales region as well as those adjacent to a periphery of the sales region, those devices heading toward the sales region, etc. As discussed below, only communication devices meeting dynamic criteria associated with probability bands within a sales region may actually be sent targeted communications so the actual area for communications may be less than the entire sales region. Thus, messages including alerts within the sales region 200 may be sent directly to the appropriate selected devices in a targeted manner based on static attributes associated with a potential customer or dynamic attributes associated with the potential customer. Often both static and dynamic attributes may be used. The message may also include directional assistance based on the current dynamic location of the device to assist the operator in taking advantage of an offering opportunity.

System 100 may provide a notification subsystem to the communication network 102. System 100 may be able to discover and send directed messages to devices 130 by way of module 160 within a sales region 200. A cell tower controller 110 may be augmented with an integrated or separate notification processor 150 and a notification module 155. The notification module 155 may be configured to send messages to select devices 130 within the sales region 200 by way of alert module 160 operating on a mobile communication device 130.

The notification processor 150 represents general processing capabilities that may be provided by a general purpose computer server or personal compute (PC), as well as by a specialized embedded system. Moreover, the notification processor 150 may be any computer system capable of operating the instructions provided by the notification module 155. As noted above, the role of the notification processor 150 may be filled by the existing equipment of the cell tower controller 110 rather then be provided by a separate element. For example, the notification module 155 may operate directly on the cell tower controller 110 equipment. Similarly, the notification processor 150 and the notification module 155 need not be co-located with the cell tower controller 110 so long as they can cooperate with the cell tower controller 110 to discover communication devices 130 within the service areas 109a-c of the cell towers 107a-c.

The notification module 155 may include instructions for discovering communication devices 130 associated with the cell towers 107a-c. The association of the communication devices 130 with the cell towers 107a-c may be based on GPS mechanisms as noted above comparing locations of the towers with the known location of the affected communication devices. Alternatively, the association of the communication devices 130 may be based on communicative contact with cell towers 107a-c therewith. As discussed above, the cell tower controller 110 may maintain records or logs of the communication devices 130 that have been in communicative contact with the cell towers 107a-c. The notification module 155 may include instructions for reviewing the logs and records of the cell tower controller 110 to discover the communication devices 130. The attributes in the records maintained by the cell tower controller 110 may further be used to determine the current dynamic location of a communication device 130. Specific locating techniques will be discussed below, but in general, the location of the device 130 may be based on the known locations of the communication facilities 105, e.g., the cell towers 107a-c. Accordingly, the notification module 155 may access the records of the cell tower controller 110 to determine the location of a set of communication devices 130 in communicative contact with the cell towers 107a-c and may then narrow the set to the appropriate devices 130 that should be notified about an offering opportunity within sales region 200.

In one exemplary approach, the current dynamic location of a particular communication device 130 is determined to be coextensive with the service area 109a of the cell tower 107a in communicative contact with the device 130. In this approach, the location of the device 130 is not known to a precise degree because the device 130 may be anywhere within the service area 109a. Broadly locating a device anywhere within the service area 109a may be necessary if the device 130 is only in contact with a single cell tower 107a. For example, in remote areas with sparse coverage by the wireless communication network 102, a device may be in contact with only a single tower 107a at any given time. Accordingly, data relating to the communicative contact between the device 130 and other towers 107b-c that is needed to narrow the location may not be available.

In another exemplary approach, the records of contact between a particular device 130 and multiple cell towers 107a-c may be used to determine a more accurate determination of the current location of the device 130. Locating techniques recognize that the time it takes a signal sent by a communication device 130 to reach the cell towers 107a-c varies with respect to the distance between the device 130 and towers 107a-c. Accordingly, the cell tower controller 110 may record the time that the same signal reaches each of the towers 107a-c as well as the time that the signal was transmitted from the device 130.

Various techniques such as triangulation, trilateration, multilateration, etc. may be used with the data held in the cell tower controller records to determine the dynamic location of the device 130. Trilateration uses the absolute time of arrival as a basis for determining a distance from a particular receiver. The distance is considered a radius of a circle, and when combined with distances (radii) from two other receivers, three partially overlapping circles may be calculated. The location of the transmitting device may be inferred as the point, or area, where the circles intersect. In contrast to trilateration, multilateration determines a location based on the time difference of the arrival time of a signal at multiple cell towers 107a-c rather than the absolute time of arrival. The differences in time are used to calculate overlapping hyperboloids rather than circles, which may be able to determine a location in three dimensions rather than just two. Triangulation may use a known distance between two cell towers 107a-b in combination with an angle of arrival of a signal from the communication device 130. The angle of arrival may be determined if the cell tower 107a includes multiple receivers. The difference in the time it takes a signal to reach each of the receivers may be used to calculate the angle of arrival. Accordingly, these techniques may be used to establish an approximate location of the device 130 based on the collective locations of the communication facilities 105, e.g., the cell towers 107a-c.

Once discovered, the notification module 155 may communicate with the alert module 160 to provide information and alert messages to the communication devices 130a. For simplicity of illustration, only a single communication device 131 is depicted with an alert module 160. However, it is to be understood that many, if not all, of the communication devices 130 associated with the mobile communication network 102 may include the alert module 160. As discussed in more detail below, the alert module 160 may be configured to present a visual and/or audible alert when within the sales region 200. The alert message may include directional assistance including at least one route toward the sales initiator when it is a point of sale 205.

A management center 165 may act as a control point or hub to provide communications to alert modules 160 within a sales region 200 of system 100. The management center 165 may include a revenue processor 170 and a revenue module 175. As discussed in more detail below, both revenue processor 170 and revenue module 175 may be influenced by geographic location (e.g., Location Based Services or LBS) configured to control the notification of communication devices 130 by the notification module 155. The processor 170 may be a server based computer system, such as a web application server configured to accept input via a web or Hyper Text Transfer Protocol (HTTP) interface. However, any computing device having a tangible computer readable medium including instructions for implementing the module 175 may act as processor 170. Processor 170 may be a networked computer system configured with server software for accepting connections via packet network 125. Processor 170 may provide an interface of commands via the revenue module.

The revenue module 175 may provide an interface of remote procedure calls that allow remote systems, such as a third party access point to interact with system 100 to provide appropriate notifications to alert modules 160 of communication devices 130. The revenue module 175 may also provide a graphical user interface (GUI), e.g., a web based interface, for use by a human operator. In one exemplary approach, the operator interface may be used for only initial configurations and exceptional or override states, while the instructions of the revenue module 175 provide the normal control over the operation of this aspect of system 100. However, in another exemplary approach, a human operator may be involved in the normal control of the system 100, e.g., determining the extent or boundary of the sales region 200, determining the content of messages sent to the communication devices 130, etc.

While FIG. 1 only illustrates a single cell tower controller 110 and three associated cell towers 107a-c, the mobile communication network 102 may include numerous cell tower controllers and cell towers. Moreover, a sales region 200 may partially or fully overlap the service areas 109a-c of multiple cell towers 107a-c, which may be associated with different cell tower controllers 110. Accordingly, the management center 165 may need to determine which cell towers 107a-c, or communication facilities 105, are associated with a sales region 200 in order to discover the communication devices 130 associated with the sales region 200. As discussed above, an operator of the network 102 typically tracks and records the geographic positions of the communication facilities 105 along with boundaries of any applicable service areas, e.g., 109a-c. The identification of affected communication facilities 105, which are associated with the sales region 200, may be based on a correlation between the sales region 200 and the geographic positions of the communication facilities 105.

To discover the communication devices 130 that should be notified, the revenue module 175 may identify affected communication facilities 105, such as cell towers 107a-c, as any communication facility 105 that provides communication services to at least a subset of the sales region 140. The devices 130 that might need to be notified may be discovered from the records of contact with the affected communication facilities 105. This set of devices 130 that might need to be contacted may be reduced to the set of devices that should be contacted based on at least the current dynamic location of each device 130 with respect to the sales region 200. The heading of a device 130 may also factor into the determination of whether the device should be notified about the sales region 140.

In one exemplary approach, management center 165 may be configured to receive information related to the sales region 200 from a third party offering entry module 180 using a data entry terminal 185. The offering entry module 180 may include instructions to communicate with the management center 165 such as by way of revenue module 175 via the packet network 125 using one or more communication protocols. For example, the entry module 180 may include web browsing software to access a web interface provided by the revenue module 175. An exemplary communication between the revenue module 175 and the offering module 190 may implement security procedures, e.g., digital certificates, an authorized users list, a private communication protocol, a private network 125, etc. to protect against fraudulent use.

Information from a third party passing through the third party offering entry module 180 may need to be validated. In one exemplary approach, the validation may be based on the identity of the provider of the offering. For example, information from certain entities associated with the maintenance of system 100 may be automatically validated while information from corporate entities or individuals may require other validation techniques. The system 100 may maintain a list or record of authorized third parties, which may be reviewed to determine if a particular provider is an authorized provider. In another exemplary approach, an offering party may not only be authorized, but also may be recognized as the competent information provider for a particular location. Accordingly, the validation may be based on the information being consistent with other information already known.

The various servers, processors and specialized devices, including, but not limited to communication devices 130, revenue processor 170 and data entry terminal 185 may be any general purpose computing device, such as a PC, or a specialized network device. The various servers, processors and specialized devices may have software, such as an operating system with low-level driver software, and the like, for receiving signals over network links. The operating system may also include a network protocol stack, for establishing and accepting network connections from remote devices.

The various servers, processors and specialized devices may employ any of a number of user-level and embedded operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a known number of computing devices, including, without limitation, a computer workstation, a desktop, notebook, laptop, handheld computer, mobile phone, smart phone, personal digital assistant, or some other known computing device.

Further, the various servers, processors and specialized devices may include instructions executable by one or more processing elements such as those listed above. Computer-executable instructions may be compiled or interpreted from computer programs created using a variety of programming languages and/or technologies known, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium, including a tangible medium, which participates in providing data (e.g., instructions), which may be read by a computer. Such a medium may take many forms, including, but not limited to, non-volatile media, and volatile media. Non-volatile media include, for example, optical or magnetic disks and other persistent memory. Volatile media include dynamic random access memory (DRAM), which typically constitutes a main memory. Common forms of tangible computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

FIGS. 2a-b illustrate two exemplary approaches to determining probability bands that represent geographical subsets within a sales region sales region and which are based on at least one dynamic attribute related to geography. A first geographic sales region 200 is illustrated in FIG. 2a that is based on a circumferential distance from a central location. The central location is represented by sales initiator 205 acting in an exemplary manner as a geographically fixed point of sale for an offering of a product or a service from a specific vendor that might be of interest to a potential customer associated with a communications device 130. It is assumed that a communication device 130 being used by a potential customer is in close geographical proximity to the potential customer.

A plurality of probability bands 210 are shown emanating away from sales initiator 205 with band 210a being the closest to the sales initiator, band 210b located further from the sales initiator and band 210c being the furthest away from the sales initiator. While three such probability bands 210 are illustrated the number of such bands is merely exemplary. Communications device 133a is located in the area between sales initiator 205 and probability band 210a. Device 133b is located in the area between probability band 210a and probability band 210c. Finally device 133c is located in the area between probability band 210b and probability band 210c. The area encompassed by probability band 210c includes the areas encompassed by probability band 210b and probability band 210a. There area is still within sales region 200. The area encompassed by probability band 210b includes the area encompassed by probability band 210a.

In one approach, it is envisioned that there is most likely a decreasing probability of a sale from the sales initiator 205 represented by the central location to a potential customer based on the dynamic attribute of distance the further a communication device 133 is from the central location. As a result, the likelihood of a communication being initiated using management center 165 decreases as the distance away from the sales initiator 205 increases. Line 215 shows the decreasing probability of a sale with respect to distance from the sales initiator 205.

The positioning of the various distance based probability bands 210 can be determined within management system 165 using predefined and automated criteria. Alternatively, input into the determination of the various probability bands 210 can be initiated by a vendor associated with the sales initiator 205 such as by using the offering entry module 180 in combination with the data entry terminal 185, as illustrated in FIG. 1. The radial distance between each of the bands may be constant or may be varied as appropriate for a particular circumstance. In general, however, it is envisioned that the radial distance of the various bands will vary as shown in FIG. 2a.

FIG. 2b illustrates a sales region 200′ that includes a combination of dynamic attributes that are used to determine access probability bands 255. Probability band 255a is shown with a nonsymmetrical shape that meanders a changing distance from sales initiator 205 within sales region 200′. Probability band 255b is shown with a more regular shape, but it is illustrated as being oval as compared to being generally circular in FIG. 2a.

While distance may be one of the dynamic attributes affecting the shape of access based probability bands within sales region 200′, it is not the only dynamic attribute that contributes to the determination of the shape of the bands and their location. For example, the access probability bands 255 may take into account the ease by which a potential customer may arrive at a point of sale 205 associated with an offering. The nature of the roads (e.g., size, speed, location, and direction of travel) or other modes of transportation (e.g., subways, walkways, and bus routes) may be exemplary additional dynamic attributes that also affect the shape of the access based probability bands 255.

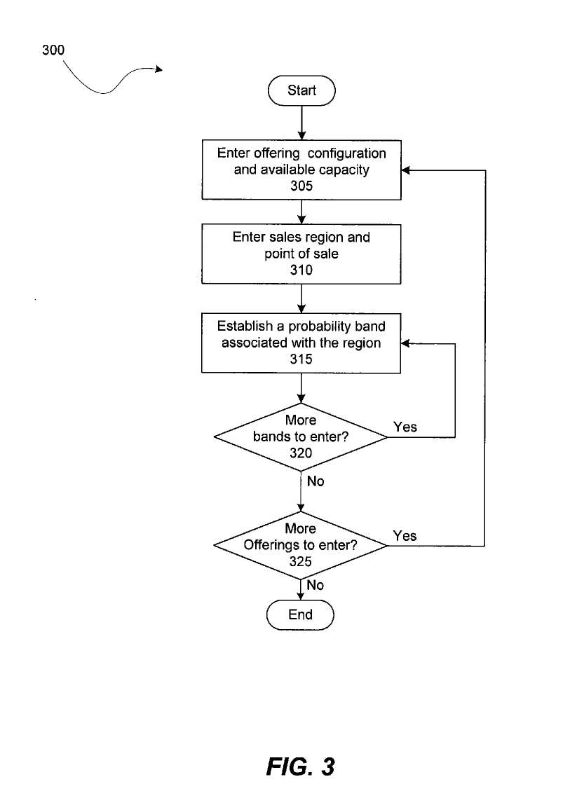

FIG. 3 illustrates a flowchart of an exemplary process 300 for entering offering capacity and data for sales region 200. The third-party terminal 185, illustrated in FIG. 1, may include a computer-readable medium having stored instructions for carrying out certain operations described herein, including some or all of the operations described with respect to process 300. For example, some or all of such instructions may be included in the offering entry module 180. As described below, some steps of process 300 may include user input and interactions. However, it is to be understood that fully automated or other types of programmatic techniques may implement steps that include user input. Further, the steps may be performed in an order other than that illustrated.

Process 300 beings in step 305, where an offering configuration and available capacity are entered into system 100. Offering configuration may include attributes related to the nature of the offering such as bundling for a particular market segment. For example, if the offering is a perishable product, the value of the product decreases over time. Thus, it may be more desirable to make an advertising offer to a greater group of potential customers within a select group of customers in view of time constraints associated with the product value. As a further example, if the fixed cost of an offering is high, but numerous potential customers can take advantage of it, reducing the overall cost of the offering for all of the accepting customers, it may again be desirable to make the advertising offer to a greater group of potential customers.

The possible need to solicit a larger audience of potential customers even if the probability of success will decrease is also an exemplary factor to be considered when there is a lot of capacity. For example, the more of a perishable product is available, the greater the need to sell it. With respect to a service such as haircuts, if there are numerous stylists available at any one time, it may be desirable to advertise more broadly then if there were only one stylist available at a sales initiator 205 representing a point of sale.

Process 300 then moves to step 310 where information related to the overall geographic limits of a sales region 200 and the geographic location of a sales initiator 205 may be entered as representations of exemplary data to be used by system 100. For instance, a vendor may be constrained from providing an offering outside of a fixed geographic region because of licensing or tax limitations and use such limitations to define the total available boundary that may be represented by a sales region 200. In another circumstance the nature of the offering is such that the geographic extent of sales region 200 may be significant with a greater consideration being made to the probability bands 210 or 255. With respect to sales initiator 205, while a single point of sale may be represented as a fixed geographic location, in other situations there may be a variety of sales initiators within a sales region (e.g., multiple dry cleaners clustered within the sales region) or the vendor may actually deliver the product or service to the potential customer.

At step 315 a probability band is established to be associated with sales region 200. The band may be determined manually or based on various dynamic attributes such as those discussed in an exemplary manner above with respect to FIG. 2a and FIG. 2b. Moreover, for example, system 100 may be able to take into account other factors to help determine the appropriate nature of a probability band. For instance, it may be desirable to know the total number of potential customers within a desired subset of total potential customers within a proposed probability band to help determine and refine the appropriate probability band size and location.

At step 320 the option is given to enter more probability bands 210 or 255. If more bands are desired then the process returns to step 315. If no more probability bands are desired the process goes to step 325.

At step 325 a determination is made as to whether further offerings need to be entered. If there are, the process returns to step 305. If not, then following step 325 process 300 ends.

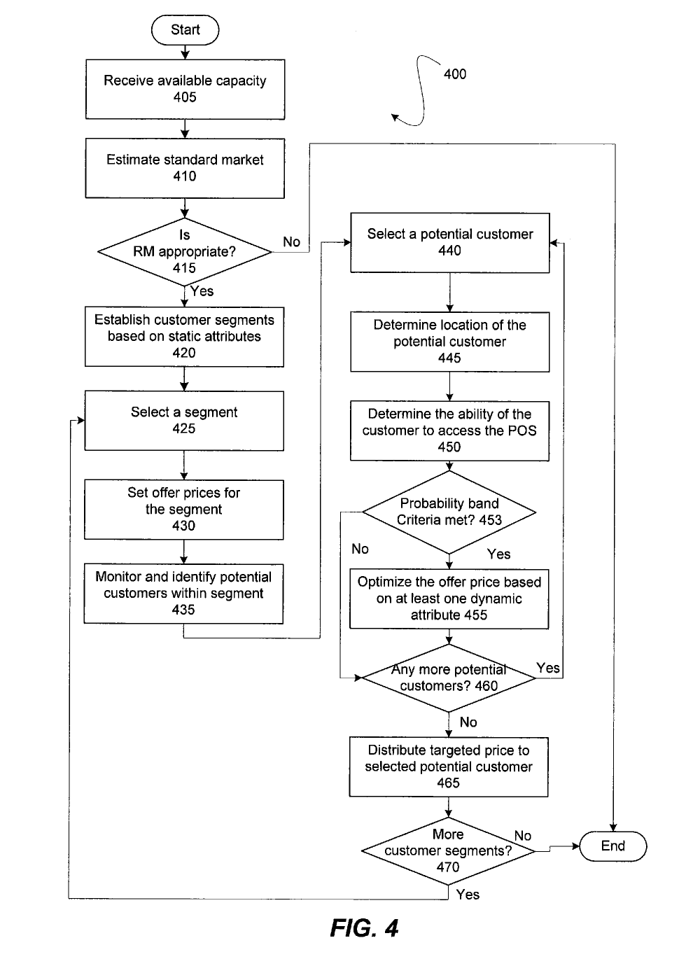

FIG. 4 illustrates a flowchart of an exemplary process 400 for conducting revenue management using location based services. The process may include hardware including a computer-readable medium having stored instructions for carrying out certain operations described herein, including some or all of the operations described with respect to process 400. For example, some or all of such instructions may be included in the revenue management module 175, as part of revenue processor 170 or as an aspect of management center 165. As described below, some steps of process 400 may include user input and interactions. However, it is to be understood that fully automated or other types of programmatic techniques may implement steps that include user input. Moreover, the steps may be undertaken in an order different then that which is illustrated.

Process 400 beings at step 405 where the available capacity associated with a specific offering is received. As noted above, the capacity may be provided as part of step 305 of process 300.

At step 410 the standard market price may be estimated, provided, or otherwise determined. In one exemplary approach the system 100 looks historically at how an offering has sold and at what price for a particular market segment of potential customers. The historical standard market price disregards both static attributes (discussed below) and dynamic attributes (discussed below) except to the extent that they are reflected historically in the standard market price.

Process 400 then moves to step 415. Process 400 determines if resource management is desired at step 415. As offer price increases, the probability of a sale decreases while the opposite is also true. As a result, marketing experts try to get to the right price (or prices for multiple customer segments) such that the multiplied mathematical product of price and probability of sale is maximized. This is known as revenue optimization or revenue management.

In general, revenue management (RM) involves maximizing revenue through differential pricing and inventory control. The methodology is typically applicable to any business where there is high capital cost or a perishable product or service to sell. For example, in the communications industry, an application or service, once deployed in the marketplace, has very high fixed costs as compared to variable costs. Thus, most of the additional sales revenue directly affects profitability. A basic tenant of RM is to continue to sell a product or service until the cost of selling an incremental or additional unit is less than the incremental revenue earned. While planning, the incremental revenue is only an estimate and depends upon the probability that a customer will buy the product and service at the offered price or the willingness of the customer to pay.

Thus, one should continue selling an offering until the incremental cost of producing an additional unit of a product or service is less than the expected marginal revenue. Expected marginal revenue is equal to the expected revenue through selling one more product or unit of a service, which in turn is equal to the price of the offer times the probability of a sale. The probability of a sale is estimated through information that is based upon relatively static attributes such as those noted above. They are expected to remain constant at least within a short time span. Thus:

Incremental cost of producing an additional unit<Expected Marginal Revenue,

where

Expected Marginal Revenue=Expected revenue through selling one more product=(Offer price based on static attributes)*(probability of a sale).

In the context of the exemplary process 400, at step 415 a determination is made whether to use RM based at least in part on the available capacity in light of or independently from the estimated standard market price. If capacity is low, for example, there may be no need to adjust the pricing using either static attributes or dynamic attributes. Process 400 ends. On the other hand, for example, if the capacity is high and there may be an advantage to setting an offer price and an optimized offer price in the form of a target price then revenue management may be appropriate. Thus, if an analysis of the available data suggests that resource management would be beneficial then process 400 continues, moving next to step 420, using a combination of static attributes and dynamic attributes in the exemplary approach as detailed below.

At step 420, process 400 establishes customer segments based on static attributes, which are generally fixed for a reasonable period of time. While optional, it is typically desirable to take the total set of potential customers and target a subset of the total number of potential customers based on one or more static attributes. Such static attributes may include, but is not limited to resident geographic information such as zip code, age group, income level, sex, and marital status.

Next at step 425 a desired customer segment is selected based on the customer segments set up in step 420. Generally, a determination is made that certain segments will be more desirable then others for the particular offering and those segments may be analyzed first for potential customers meeting the criteria of process 400. Then the process moves onto step 430.

At step 430 static offer prices are set for a pre-selected segment using one or more of the static attributes noted above. Different segments may get different pricing depending on the characteristics of the segment. For example, youth getting an offer to go to a restaurant may require a price that is less than that of adults, but a customer segment of adults may be selected first. Thus, the offer price for first selected, higher priority selected adult customer segment will be greater than a later selected, lower priority youth selected customer segment. On the other hand, for certain offerings (e.g., a new musical offering or fashion items), a youth selected customer segment may pay a higher price and thus warrant a higher priority then a corresponding adult-based customer segment.

Once a segment is selected, a key goal is to offer real-time targeted advertisements using system 100 to alert modules 160 of communication devices 130 within a desired probability band 210, 255 within a sales region 200 with an optimized offer price (i.e., targeted price) to maximize revenue.

In general, beginning at step 440 system 100 integrates teachings of RM with a location based services (LBS). Under RM the probability of a customer buying an offering was attributed to the historical behavior of the segment that the customer belonged to. As discussed above, for marketing purposes, customers were divided into multiple segments based on static attributes. However, by adding at least one dynamic attribute, such as one involving customer location, distance to an offering, or accessibility to reach the offering, it may be possible to make a much better estimation of a willingness of a potential customer to pay and to set an appropriate target price. For example, a potential customer within one mile of a retail store may be much more likely to want to receive and take advantage of a store promotion by way of an alert received using alert module 160 as generated by management system 165, as compared to an individual who is located thirty miles away. On the other hand, distance may not be the only factor. Ease of getting to the retail store, for example, may result in a potential customer a further distance away being more interested in a promotion then one that is located a closer distance, but impeded by physical infrastructure to travel to the store. Some exemplary implementations may only look at dynamic attributes and target all potential customers within at least a subset of the sales region 200 regardless of customer segment, such as when static attributes are less helpful to setting an offer price that can be optimized using the at least one dynamic attribute.

At step 435, once a static offer price has been set for a selected customer segment the process monitors and identifies potential customers within the customer segment. The step may include a determination of all potential customers within a particular customer segment within a sales region 200, understanding that only a subset of the potential customers will most likely be selected within the sales region 200.

At step 440, using one exemplary approach, a potential customer will be selected from the set of potential customers for receiving an advertising communication associated with sales initiator 205 through system 100.

Then at step 445 the current dynamic location of the customer will be determined. The determination may include one of the approaches discussed above with respect to communication network 102.

More specifically, after step 445 the process 400 determines the ability of the customer to access the sales initiator 205 using the probability bands 210 or 255 discussed above, recognizing that probability will be a factor of at least one dynamic attributes such as distance when the sales initiator is a point of sale or the like.

Then, in step 450, the process determines the ability of the customer to access the sales initiator 205. If the probability band criteria are met as shown at decision point 453 then the offer price is optimized into a targeted price based on the at least one dynamic attribute as shown at step 455. For example, as noted above process 400 may recognize that the probability of a sale is greater the closer a potential customer within a customer segment is to the point of sale of a sales initiator 205.

At step 460 process 400 determines if there are any additional potential customers that need to be considered. If there are, then the process loops back to step 440. Otherwise, the process moves to step 465.

While these particular method steps are illustrated other approaches are possible. For example, it may be desirable in some implementations to locate potential customers using dynamic attributes first (e.g., the total group of potential customers in a particular probability band) and then to fit them into particular customer segments.

At step 465 an advertising communication such as targeted price is sent to each of the identified potential customers using the mechanism discussed above in FIG. 1 by way of communication network 102. While step 465 is shown taking place after step 460, this order is merely exemplary. It may be desirable to send the communication immediately after step 455 for each customer if the price is different for each potential customer. However, if an optimized price is set for those customers within a specific probability band 210, 255 before moving onto a lower probability band, it may be more desirable to send the communication to a group of potential customers at one time.

Finally, in step 470, process 400 determines if it should consider other customer segments (e.g., youth potentially interested in a restaurant as set forth above). If the answer is yes, then the process loops back to step 425. Otherwise, process 400 ends.

Accordingly, an exemplary method for selectively transmitting advertising based communications by way of a communication network using a mixture of static attributes and/or static attributes has been described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain systems, and should in no way be construed so as to limit the claimed invention.

Accordingly, it is to be understood that the above description is intended to be illustrative and not restrictive. Many systems and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future systems. In sum, it should be understood that the disclosure is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites explicitly to the contrary.

What is claimed is:

1. A method comprising:
setting an offering price for an offering in the form of at least one of a product and service;
monitoring a geographic sales region for at least one potential customer;
optimizing the offering price to a targeted price based on at least one dynamic attribute of the at least one potential customer; and
distributing the targeted price to the at least one potential customer.

2. The method of claim 1, further comprising:
determining the geographic location of the at least one potential customer; and
using the location of the potential customer as the at least one dynamic attribute.

3. The method according to claim 2, further comprising:
locating a sales initiator by way of geography;
estimating the ability of the potential customers to access the sales initiator; and
using the estimated ability of the potential customers to access the sales initiator as the at least one dynamic attribute.

4. The method according to claim 3, further comprising:
utilizing a communication network having a communication device in physical proximity to the at least one potential customer;
determining the location of the at least one potential customer by locating the communication device within the communication network; and
basing the estimate of the ability of the potential customer to access the point of sale on the location being associated with a sales region.

5. The method according to claim 3, further comprising:
Utilizing a communication network having a communication device in physical proximity to the at least one potential customer;
determining the location of the at least one potential customer by locating the communication device within the communication network; and
basing the estimate of the ability of the potential customer to access the point of sale on a distance between the location and a sales initiator acting as a geographically fixed point of sale.

6. The method according to claim 1, further comprising:
the at least one potential customer including a plurality of potential customers;
grouping the plurality of potential customers into at least one segment; and
offering the product to each customer of a segment at a corresponding targeted price.

7. The method according to claim 6, wherein the grouping of the plurality of potential customers utilizes at least one static attribute that is generally fixed in time.

8. The method according to claim 1, further comprising:
receiving an availability capacity for the offering;
basing at least in part a determination that revenue management is appropriate on the availability capacity.

9. The method according to claim 1, further comprising:
basing the offering price on at least one static attribute of the potential customer.

10. The method of claim 1, further comprising the establishing of at least one probability band within the geographic sales region.

11. The method of claim 10, further comprising:
locating a sales initiator by way of geography; and
establishing the probability band at least in part on the sales initiator.

12. The method of claim 11, wherein the probability band is determined based on at least one of a distance from the sales initiator and an accessibility to the sales initiator.

13. A method comprising:
determining that revenue management is appropriate for an offering of at least one of a product and a service;
establishing at least one customer segment based on at least one static attribute;
setting an offer for each segment of the at least one customer segment;
optimizing the offer price into a targeted price based on at least one dynamic attribute of the segment; and
distributing the respective targeted prices to potential customers of the at least one customer segment.

14. The method according to claim 13, further comprising:
determining a current geographic location of each of the potential customers;
using the location as the at least one dynamic attribute.

15. The method of claim 14, further comprising the establishing of at least one probability band within the geographic sales region.

16. The method of claim 15, further comprising:
locating a sales initiator by way of geography; and
establishing the probability band at least in part on the sales initiator and the current geographic location of each of the potential customers.

17. The method of claim 16, wherein the probability band is determined based on at least one of a distance from the sales initiator and an accessibility to the sales initiator.

18. The method according to claim 14, further comprising:
locating a point of sale by way of geography;
estimating the ability of the potential customers to access the point of sale; and
using the estimated ability of the potential customers to access the point of sale as the at least one dynamic attribute.

19. The method according to claim 18, further comprising:
determining the location of the at least one potential customer by locating a communication device associated with the at least one potential customer within the communication network;
establishing a geographic sales region within the communication network; and
basing the estimate of the ability of the potential customer to access the point of sale on the location being associated with the sales region.

20. The method according to claim 18, further comprising:
determining the location of the at least one potential customer by locating a communication device associated with the at least one potential customer within the communication network; and
basing the estimate of the ability of the potential customer to access the point of sale on a distance between the location and the point of sale.

21. The method according to claim 13, further comprising:
receiving an availability capacity for the offering;
basing at least in part a determination that revenue management is appropriate on the availability capacity.

22. A system comprising:
a processor configured to communicate with at least one communication device participating in a network, a memory selectively communicating with the processor and having a computer readable medium including instructions for controlling the processor to:
set an offering price for at least one of a product and service;
monitor a sales region by at least selectively receiving input from the at least one communication device, the input determining a location of the at least one communication device within the network;
optimize the offering price to a targeted price selectively communicated to the at least one communication device based on at least one dynamic attribute associated with at least one communication device;
distribute the targeted price to the communication device; and
use the location of the communication device as the at least one dynamic attribute.

23. The system according to claim 22, further comprising additional instructions in the computer readable medium for controlling the processor to:
estimate the ability of the at least one communication device to access a geographically based point of sale; and
use the estimated ability to access the point of sale as the at least one dynamic attribute.

24. The system according to claim 23, further comprising additional instructions in the computer readable medium for controlling the processor to:
base the estimate of the ability of the at least one communication device to physically access the point of sale from the location.

25. The system according to claim 23, further comprising additional instructions in the computer readable medium for controlling the processor to:
base the estimate of the ability of the at least one communication device to access the point of sale on a distance between the location and the point of sale.
